(19) United States
(12) Patent Application Publication
(10) Pub. No.: US 2019/0099832 A1
(43) Pub. Date: Apr. 4, 2019

(54) FRICTION ELEMENT WELDING TAPE FEED WASHER FOR ISOLATION

(71) Applicant: Ford Global Technologies, LLC, Dearborn, MI (US)

(72) Inventors: Amanda Kay Freis, Ann Arbor, MI (US); David John Hill, Ann Arbor, MI (US)

(73) Assignee: Ford Global Technologies, LLC, Dearborn, MI (US)

(21) Appl. No.: 15/719,641

(22) Filed: Sep. 29, 2017

(51) Int. Cl. B23K 20/12

(52) U.S. Cl. CPC B23K 20/129; B23K 9/206; B23K 20/128

(57) ABSTRACT

A corrosion barrier for use under heads of a plurality of friction elements in a structural assembly and a method of installing the corrosion barrier are provided. The corrosion barrier defines a plurality of spaced apertures extending along a length of the corrosion barrier and a corresponding plurality of perforations concentrically located around the spaced apertures. A plurality of friction elements within a corresponding plurality of spaced apertures in a corrosion barrier forms a friction element strip assembly that is loaded into two workpieces. The two workpieces are joined together after an area of corrosion barrier is removed.

### FIELD

The present disclosure relates generally to friction elements and more particularly to corrosion protection for use in joining adjacent workpieces.

### BACKGROUND

The statements in this section merely provide background information related to the present disclosure and may not constitute prior art.

A variety of structures being joined often require corrosion protection, and this is especially true for automotive assemblies such as body panels. One such technique for joining structures is a friction element welding process, where heat is generated by rotation of a friction element (i.e., fastener) under application of an axial force. The friction element is connected to the structures during partial melting of the friction element, or portions thereof, and the mating structure.

Referring to FIG. 1, an exemplary friction element weld process is illustrated through a series of progressive illustrations, in which a friction element 1 is rotated at high RPMs (revolutions per minute) and applied with an axial force to an upper piece 2 and a lower piece 3. As the friction element 1 is rotated and the axial force is applied, the materials of the upper and lower pieces 2/3 soften, thus allowing the friction element 1 to penetrate these pieces. When the head 4 of the friction element 1 abuts the upper piece 2, the rotation and axial force applied to the friction element 1 are removed, and then the materials of the upper and lower pieces 2/3 recrystallize, thus forming a mechanical connection between the friction element 1 and the upper and lower pieces 2/3 and a friction welded assembly 5. Such a fastening method can be efficient and economical in high production environments, such as the assembly of automotive body parts/panels.

One known method and friction element for use in this type of friction welding for automotive body parts/panels is the EJOWELD® friction welding method and rivet-type friction element. However, this method can present issues since the interface between the head 4 of the friction element 1 and the structures being joined (upper piece 2/lower piece 3) may be exposed to environmental substances that can penetrate the interfaces and eventually cause corrosion.

This corrosion issue in joined assemblies using a friction welding method and related friction elements, among other mechanical joining issues, is addressed by the present disclosure.

### SUMMARY

In one form of the present disclosure, a corrosion barrier for use under heads of a plurality of friction elements in a structural assembly is provided. As used herein, the term “structural assembly” includes both structures that carry load and those that do not carry any appreciable loads, e.g. fairings/facia. The corrosion barrier defines a plurality of spaced apertures extending along a length of the corrosion barrier and a corresponding plurality of perforations concentrically located around the spaced apertures.

According to various forms of the corrosion barrier, the plurality of spaced apertures may define a circular geometry configured to receive the plurality of friction elements. The plurality of perforations may also define a circular geometry. The area between each of the spaced apertures and each of the perforations may define a washer configured for placement under the heads of the plurality of friction elements. The plurality of spaced apertures and perforations may be evenly spaced.

In one variation, the corrosion barrier defines a rectangular geometry having upper and lower longitudinal edges and a plurality of locating apertures disposed along the upper and lower longitudinal edges. In this form, a width of the corrosion barrier may be about 10 mm greater than a diameter of each of the heads of the friction elements.

In another variation, the area between the each of the spaced apertures and each of the perforations defines a removable member, and the perforations are configured to separate the removable member from the corrosion barrier as a function of at least one of material properties of the corrosion barrier, a size of the spaced apertures, and a spacing of the spaced apertures.

In another form of the present disclosure a friction element strip assembly is provided that comprises a plurality of friction elements and a corrosion barrier for use under heads of the plurality of friction elements. The corrosion barrier defines a plurality of spaced apertures extending along a length of the corrosion barrier and a corresponding plurality of perforations concentrically located around the spaced apertures. The plurality of spaced apertures may define a circular geometry configured to receive the plurality of friction elements. The plurality of perforations may also define a circular geometry. The area between each of the spaced apertures and each of the perforations may define a washer configured for placement under the heads of the plurality of friction elements. The plurality of spaced apertures and perforations may be evenly spaced.

In one variation, the corrosion barrier defines a rectangular geometry having upper and lower longitudinal edges and a plurality of locating apertures disposed along the upper and lower longitudinal edges. In another form, a width of the corrosion barrier is about 10 mm greater than a diameter of each of the heads of the friction elements.

In another variation, an area between the each of the spaced apertures and each of the perforations defines a removable member, and the perforations are configured to separate the removable member from the corrosion barrier as a function of at least one of material properties of the corrosion barrier, a size of the spaced apertures, and a spacing of the spaced apertures.

In yet another form, the present disclosure provides a method of installing a corrosion barrier under heads of a plurality of friction elements in a structural assembly. The method comprises the steps of:

locating a plurality of friction elements within a corresponding plurality of spaced apertures in a corrosion barrier to form a friction element strip assembly, the fastener strip assembly defining a corresponding plurality of perforations concentrically located around the spaced apertures;

loading the friction element strip assembly into the two workpieces;

securing the friction element strip assembly; and

removing an area of the corrosion barrier such that only a removable member between the apertures and the perforations remains under the heads of the friction elements.

In one variation, the corrosion barrier defines a rectangular geometry having upper and lower longitudinal edges and a plurality of locating apertures disposed along the upper and lower longitudinal edges, wherein the locating apertures are aligned with pins before loading the friction element strip assembly into the two workpieces. The area of the corrosion barrier that is not installed under the heads of the friction elements may be recycled. In another form, the friction element strip assembly is gravity fed into an installation machine prior to locating the plurality of friction elements.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a series of progressive cross-sectional views illustrating a friction welded structural assembly and a friction weld element/fastener according to the prior art;

FIG. 2 is a cross-sectional view of a structural assembly having a removable member constructed in accordance with the teachings of the present disclosure;

FIG. 3 is a top view of a corrosion barrier in accordance with one form of the present disclosure;

FIG. 4A is a top view of a friction element strip assembly having friction elements inserted through a number of apertures of a corrosion barrier in accordance with the present disclosure;

FIG. 4B is a side view of the friction element strip assembly of FIG. 4A;

FIG. 5A is a side cross-sectional view of a friction element strip assembly held above two workpieces prior to installation of the friction elements in accordance with the present disclosure;

FIG. 5B is a side cross-sectional view of the friction element strip assembly of FIG. 5A after installation of the friction elements through an upper workpiece and into a lower workpiece;

FIG. 5C is a side cross-sectional view of the corrosion barrier strip of FIG. 5B being removed after friction element installation in accordance with the present disclosure;

FIG. 5D is a side cross-sectional view of the corrosion barrier of FIG. 5C completely removed and removable members remaining under heads of the installed friction elements in accordance with the present disclosure; and

FIG. 6 is a flow chart illustrating a method of installing a corrosion barrier under heads of a plurality of friction elements in accordance with the present disclosure.

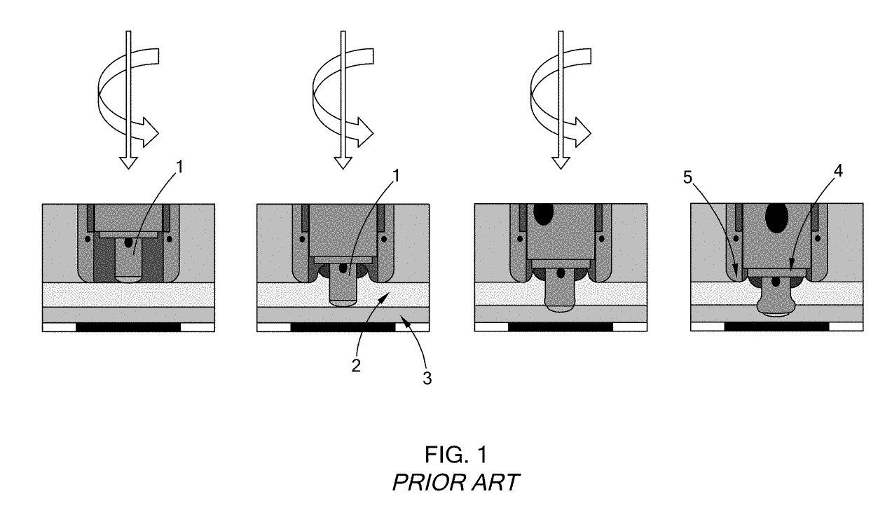

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

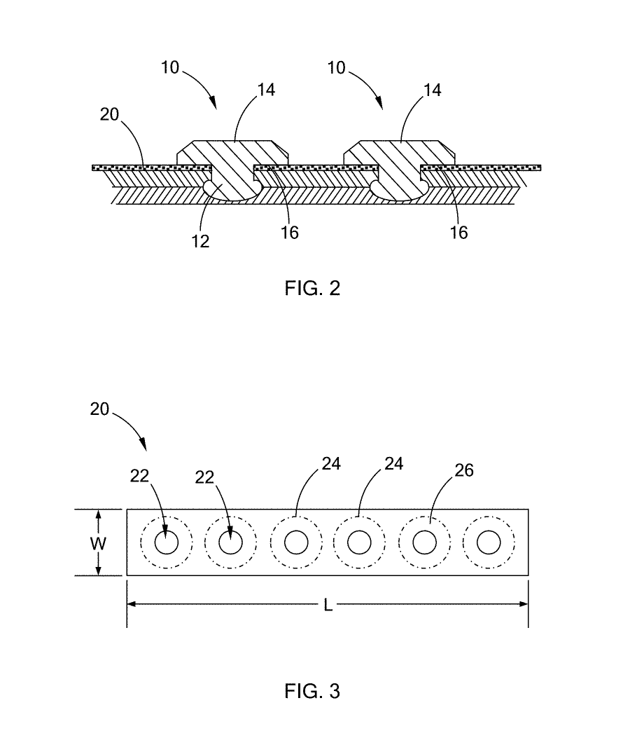

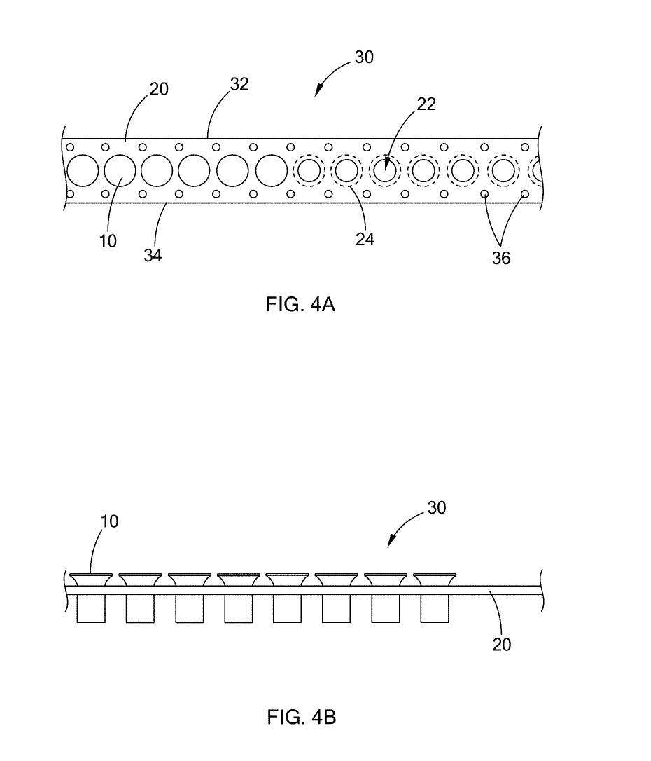

Referring to FIGS. 2 and 3, a corrosion barrier for use under heads of friction elements 10 in a structural assembly according to the principles of the present disclosure is illustrated and generally indicated by reference numeral 20. The corrosion barrier 20 defines a plurality of spaced apertures 22 extending along a length L of the corrosion barrier 20, and a corresponding plurality of perforations 24 concentrically located around the spaced apertures 22. In one form, the plurality of spaced apertures 22 define a circular geometry configured to receive the friction elements, and more specifically the shafts 12 of the friction elements 10. However, it should be understood that the plurality of spaced apertures 22 may define geometric shapes other than circles, which would be a function of the shape of the friction element shaft 12. The corrosion barrier 20 also functions as a transfer mechanism to move the friction elements 10 into position relative to workpieces to be joined, as described in greater detail below.

Each friction element 10 also defines a head 14 as shown. The plurality of perforations 24 define a geometric shape configured to correspond to the geometric shape of the head 14, and more specifically the shape of a distal face 16. As shown, the plurality of perforations 24 define a circular geometry to correspond to a circular distal face 16 of the friction element 10. However, this circular geometry should not be construed as limiting the scope of the present disclosure since other shapes may be employed, such as by way of example, square, hexagonal, and other polygonal geometries. Generally, the perforations 24 create a controlled fracture location along the corrosion barrier 20 and can be in the form of scoring or a scribe, which allows the material to separate at the perforations 24.

In still another form of the present disclosure, the corrosion barrier 20 could be configured without the perforations 24 and the rotational speed of the friction weld element (i.e., friction element 10) at installation would shear the corrosion barrier 20 proximate the heads of the friction elements 10. This could be accomplished, for example, with a predetermined rotational speed at installation versus the material and thickness of the corrosion barrier 20. Therefore, the perforations 24 may not be needed in another form of the present disclosure.

An area of the corrosion barrier 20 between the each of the spaced apertures 22 and each of the perforations 24 defines a removable member 26 configured for placement under the heads 14 of the plurality of friction elements friction elements 10 to form a local corrosion barrier. In one form, this removable member 26 is a washer as shown. Installation of the corrosion barrier 20 and how the removable members 26 are removed to form individual/local washers/elements under the friction element heads 14 is described in greater detail below.

The size and spacing of the plurality of spaced apertures 22 and perforations 24 depends on the structural assembly, and in one form, the plurality of spaced apertures 22 and perforations 24 are evenly spaced to correspond to evenly spaced friction elements friction elements 10. Alternatively, the spaced apertures 22 and perforations 24 may not be evenly spaced as a function of the design of the structural assembly. In still another form, the spaced apertures 22 and perforations 24 may be evenly spaced but with different sizes/shapes and/or unevenly spaced with the same or different sizes/shapes. Each of these variations is to be construed as being with the scope of the present disclosure.

In one form of the present disclosure, a width W of the corrosion barrier 20 is about 10 mm greater than the diameter of the heads 14 of each of the friction elements friction elements 10. However, other widths may be employed while remaining within the scope of the present disclosure. Materials for the corrosion barrier 20 may include, by way of example, thermoplastic polymer, a closed cell foam, a wax-dipped fiber mat, or a non-ferrous metal.

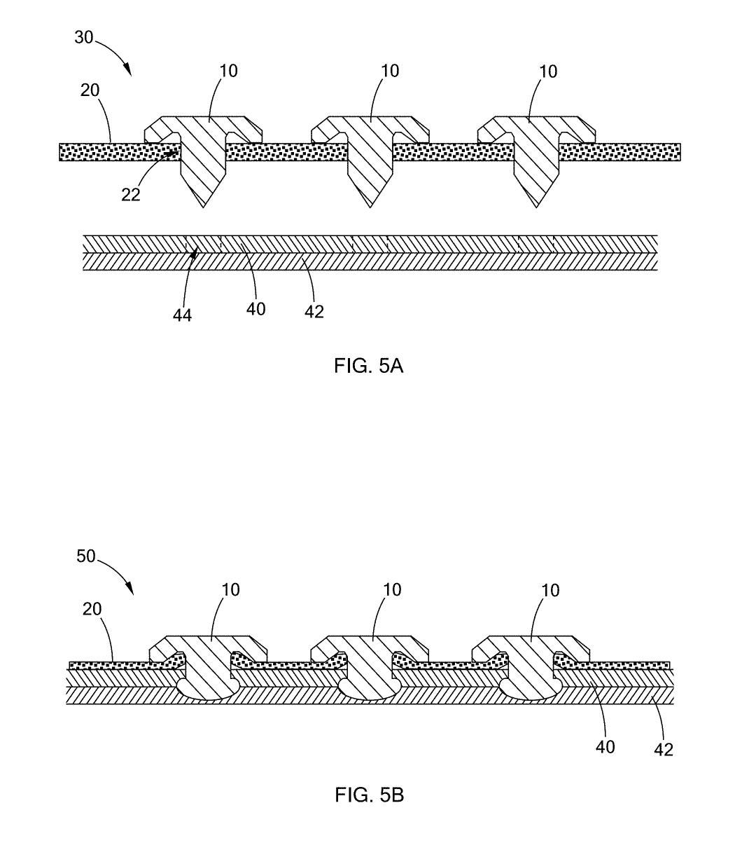

Referring now to FIGS. 4A and 4B, a friction element strip assembly according to the present disclosure is illustrated and generally indicated by reference numeral 30. The friction element strip assembly 30 comprises a plurality of friction elements 10 and the corrosion barrier 20. As shown, the friction elements 10 are inserted into the spaced apertures 22, and some friction elements have not been inserted for purposes of clarity in viewing the spaced apertures 22 and perforations 24. The friction element strip assembly 30 defines upper and lower longitudinal edges 32, 34, and a plurality of locating apertures 36. The locating apertures 36 function to locate the friction element strip assembly 30 into a feeder/machine (not shown) that delivers the friction element strip assembly 30 to a structural assembly for installation of the friction elements friction elements 10, as described in greater detail below. Analogously, and for clarity purposes only, the locating apertures 36 function similar to the edges of dot matrix paper that are used to engage feeder pins of a dot matrix printer to continuously feed the paper. Therefore, the locating apertures 36 allow for continuous feeding of the friction element strip assembly 30 with improved accuracy before installation of the friction elements friction elements 10.

It should be understood that this shape and configuration of a friction element strip assembly 30 is only exemplary and that other configurations (e.g., not rectangular and/or without locating apertures 36) may be employed while remaining within the scope of the present disclosure. The function of the friction element strip assembly 30 is to deliver the friction elements friction elements 10 to the structural assembly for installation, using the innovative corrosion barrier 20 according to the teachings of the present disclosure.

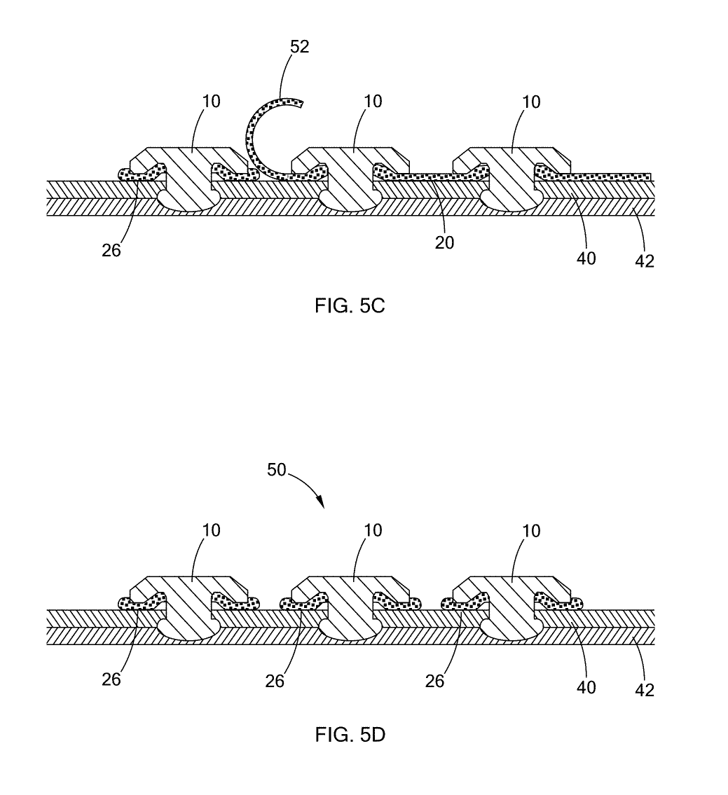

Referring to FIGS. 5A-5D, installation (and removal of a portion of) the corrosion barrier 20 is illustrated through a series of progressive illustrations. Although a friction welding process is represented for installation of the friction elements, it should be understood that friction welding is merely exemplary and other friction element installation/joining technologies, such as for example, resistance welding and riveting, among others, may be employed while remaining within the scope of the present disclosure.

In FIG. 5A, the friction element strip assembly 30 is shown pre-positioned above upper and lower workpieces 40, 42. Although two (2) workpieces 40, 42 are shown, the structural assembly 50 (FIG. 5B) may include more than two workpieces and thus the illustration of an upper and lower workpiece 40,42 should not be construed as limiting the scope of the present disclosure. Further, the friction elements 10 may be of different sizes and spacing depending on application requirements and thus the illustration of evenly spaced friction elements 10 of the same size should not be construed as limiting the scope of the present disclosure. In one form, the corrosion barrier 20 would carry/transport groups of friction elements for installation, for example one group being one diameter, and other groups being different diameters.

As shown, the plurality of friction elements 10 are located and placed within the corresponding plurality of spaced apertures 22 of the corrosion barrier 20 to form the friction element strip assembly 30. The plurality of friction elements 10 are aligned with and placed into optional apertures/clearance holes 44 of the upper workpiece 40. In one form, the friction element strip assembly 30 is gravity fed into an installation machine (not shown). After the friction elements 10 are located, an installation tool from the friction welding equipment (described above) progressively installs the friction elements 10 to the workpieces 40, 42, as shown in FIG. 5B.

In FIG. 5B, the plurality of friction elements 10 are shown installed to the upper and lower workpieces 40, 42 to form a structural assembly. However, note that the corrosion barrier 20 remains across the length of the installation area and under the heads of the friction elements 10. The area between the friction elements 10 temporarily includes the corrosion barrier 20, which is removed by pulling the corrosion barrier 20 away from the upper substrate 40 as shown in FIG. 5C.

As shown in FIG. 5C, the corrosion barrier 20 is removed such that only the removable members 26 between the spaced apertures 22 and perforations 24 remains under the heads of the friction elements 10. The perforations 24 create a weak area in the material of the corrosion barrier 20, allowing the removable members 26 to remain due to the force being applied by the heads of the friction elements 10 as the corrosion barrier 20 is being pulled off. In one form, the perforations 24 are configured to separate the removable member 26 from the corrosion barrier 20 as a function of at least one of material properties of the corrosion barrier 22, a size of the spaced apertures 22, and a spacing of the spaced apertures 22. It should be understood, however, that the corrosion barrier 20 may remain in its entirety after installation of the friction elements 10, without being removed as illustrated and described herein, while remaining within the scope of the present disclosure.

The portion of the corrosion barrier that remains after removal is referred to as a remnant 52, which may be recycled.

Referring to FIG. 5D, the final structural assembly 50 of the two workpieces 40, 42, the friction elements, and the removable members 26 (which in this form are washers) is illustrated. The corrosion barrier 20 between the friction elements 10 has been removed, by virtue of the perforations 24, leaving only the removable members 26, which themselves function as a corrosion barrier in the structural assembly 50. In one form, the removable members 26 extend beyond the heads of the friction elements 10, in which form they are a material that can flow during the installation process, such as an expanding foam. As shown, the material of the removable members 26 migrates outside the friction element head and also into the recess under the heads of each friction element 10. Accordingly, the friction element strip assembly 30 allows for easier and more accurate installation of both the friction elements 10, and corrosion barriers between the friction elements 10 and the workpieces 40, 42, without having to handle/locate individual corrosion barriers (i.e., washers) prior to friction element installation.

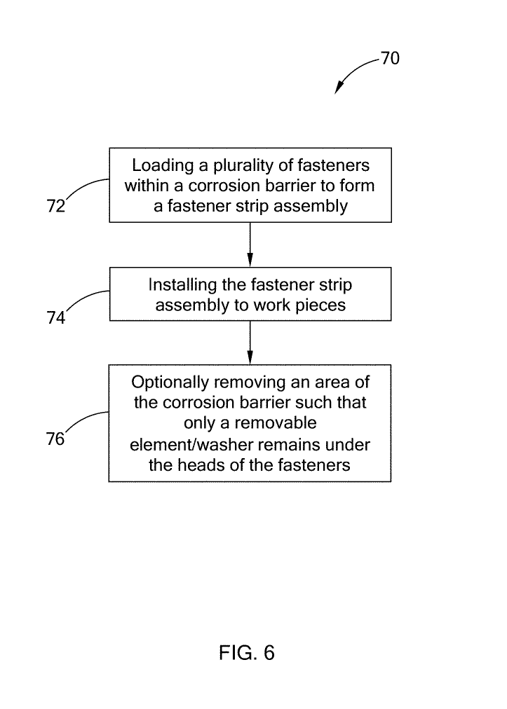

Referring now to FIG. 6, a method of installing a corrosion barrier under heads of a plurality of friction elements in a structural assembly, as illustrated and described above, is shown in a flow diagram format. The method 70 comprises a step 72 of loading a plurality of friction elements in a corrosion barrier to form a friction element strip assembly. The friction element strip assembly in one form defines a corresponding plurality of perforations concentrically located around the spaced apertures. (FIG. 3).

Next, the method includes a step 74 of installing the friction element strip assembly to two work pieces. Optionally, an area of the corrosion barrier is removed in step 76 such that only the removable member between the apertures and the perforations remains under the heads of the friction elements. (FIG. 5C). In one form, an area of the corrosion barrier that is not installed under the heads of the friction elements (the remnant) is recycled.

It should be understood that the friction element weld process illustrated and described herein is merely exemplary, and thus the teachings of the present disclosure are also applicable to other joining technologies and applications, such as for example, resistance welding, and riveting, among others. Therefore, the friction element weld process should not be construed as limiting the scope of the present disclosure. Such variations should be construed as falling within the scope of the present disclosure.

The description of the disclosure is merely exemplary in nature and, thus, variations that do not depart from the substance of the disclosure are intended to be within the scope of the disclosure. Such variations, such as those disclosed in U.S. application Ser. No. 15/382,607, which is commonly assigned with the present application and incorporated herein by reference in its entirety, are not to be regarded as a departure from the spirit and scope of the disclosure.

What is claimed is:

1. A corrosion barrier for use under heads of a plurality of friction elements in a structural assembly, the corrosion barrier defining a plurality of spaced apertures extending along a length of the corrosion barrier and a corresponding plurality of perforations concentrically located around the spaced apertures.

2. The corrosion barrier according to claim 1, wherein the plurality of spaced apertures define a circular geometry configured to receive the plurality of friction elements.

3. The corrosion barrier according to claim 1, wherein the plurality of perforations define a circular geometry.

4. The corrosion barrier according to claim 1, wherein an area between the each of the spaced apertures and each of the perforations defines a washer configured for placement under the heads of the plurality of friction elements.

5. The corrosion barrier according to claim 1, wherein the plurality of spaced apertures and perforations are evenly spaced.

6. The corrosion barrier according to claim 1, wherein the corrosion barrier defines a rectangular geometry having upper and lower longitudinal edges and a plurality of locating apertures disposed along the upper and lower longitudinal edges.

7. The corrosion barrier according to claim 6, wherein a width of the corrosion barrier is about 10 mm greater than a diameter of each of the heads of the friction elements.

8. The corrosion barrier according to claim 1, wherein an area between the each of the spaced apertures and each of the perforations defines a removable member, and the perforations are configured to separate the removable member from the corrosion barrier as a function of at least one of material properties of the corrosion barrier, a size of the spaced apertures, and a spacing of the spaced apertures.

9. A friction element strip assembly comprising:
a plurality of friction elements; and
a corrosion barrier for use under heads of the plurality of friction elements, the corrosion barrier defining a plurality of spaced apertures extending along a length of the corrosion barrier and a corresponding plurality of perforations concentrically located around the spaced apertures.

10. The friction element strip assembly according to claim 9, wherein the plurality of spaced apertures define a circular geometry configured to receive the plurality of friction elements.

11. The friction element strip assembly according to claim 9, wherein the plurality of perforations define a circular geometry.

12. The friction element strip assembly according to claim 9, wherein an area between the each of the spaced apertures and each of the perforations defines a washer configured for placement under the heads of the plurality of friction elements.

13. The friction element strip assembly according to claim 9, wherein the plurality of spaced apertures and perforations are evenly spaced.

14. The friction element strip assembly according to claim 9, wherein the corrosion barrier defines a rectangular geometry having upper and lower longitudinal edges and a plurality of locating apertures disposed along the upper and lower longitudinal edges.

15. The friction element strip assembly according to claim 14, wherein a width of the corrosion barrier is about 10 mm greater than a diameter of each of the heads of the friction elements.

16. The friction element strip assembly according to claim 9, wherein an area between the each of the spaced apertures and each of the perforations defines a removable member, and the perforations are configured to separate the removable member from the corrosion barrier as a function of at least one of material properties of the corrosion barrier, a size of the spaced apertures, and a spacing of the spaced apertures.

17. A method of installing a corrosion barrier under heads of a plurality of friction elements in a structural assembly comprising:
loading a plurality of friction elements within a corresponding plurality of spaced apertures in a corrosion barrier to form a fastener strip assembly, the friction element strip assembly defining a corresponding plurality of perforations concentrically located around the spaced apertures;
installing the friction element strip assembly to the two workpieces; and
optionally removing an area of the corrosion barrier such that only a removable member between the apertures and the perforations remains under the heads of the friction elements.

18. The method according to claim 17, wherein the corrosion barrier defines a rectangular geometry having upper and lower longitudinal edges and a plurality of locating apertures disposed along the upper and lower longitudinal edges, wherein the locating apertures are aligned with pins before loading the friction element strip assembly into the two workpieces.

19. The method according to claim 17, wherein an area of the corrosion barrier that is not installed under the heads of the friction elements is recycled.

20. The method according to claim 17, wherein the friction element strip assembly is gravity fed into an installation machine prior to locating the plurality of friction elements.
